(19) United States
(12) Patent Application Publication
(10) Pub. No.: US 2004/0025111 A1
(43) Pub. Date: Feb. 5, 2004

(54) Reading device and method thereof using display

(76) Inventor: Gyu-Jin Park, Kyungki-do (KR)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/343,390

(22) PCT Filed: Aug. 3, 2001
(86) PCT No.: PCT/KR01/01326

(30) Foreign Application Priority Data
Aug. 4, 2000 (KR) 2000-45383

(51) Int. Cl. G06F 17/00

(52) U.S. Cl. 715/500

(57) ABSTRACT

Disclosed is a reading device such as an electronic book, a digital caption player and a PDA having a display such as an LCD that comprises a storage unit for storing text data to be displayed; a selector for a user to select a fast reading mode and data; a controller for reading the text data from the storage unit for each selected data in response to the selected fast reading mode and the data and providing the read data according to the selected fast reading mode; and a display for receiving the data and visually displaying the data. According to the present invention, the user can improve the user's reading comprehension and select a desired fast reading training method so as to improve the fast reading ability within a shorter time frame.

### BACKGROUND OF THE INVENTION

(a) Field of the Invention

The present invention relates to a reading device and method using a display. More specifically, the present invention relates to a reading device and method using a display for effective reading, and a computer-readable recording medium that records a program for implementing the method. Further, the present invention relates to a speed-reading training device using a display, and a computer-readable recording medium that records a program for implementing the speed-reading training.

(b) Description of the Related Art

As computer technologies have developed and grown in popularity, electronic documents and publications have also increased. In particular, personal documents or papers are made by using word processing programs, and most documents accessible on the Internet are in electronic format.

In order to read these electronic documents, a user uses a display such as a computer monitor or an LCD. In this instance, the user uses a mouse or the up/down arrow keys on a computer keypad. However, the user's manipulation of the mouse or the keypad generates problems to the user's ability to read the electronic documents. That is, when the user is required to read the electronic documents intensively, the user must continuously manipulate the mouse or the keypad to adjust their reading speed, and accordingly, this lowers the user's reading efficiency. Also, it is not easy for the user to concentrate on the documents because of the constant display method. Therefore, a new display method is required for the user to read a large volume of electronic documents within a limited time frame.

Further, in order to obtain more information from reading, speed-reading training programs currently exist for text media, but speed-reading training for electronic documents or electronic displays has not yet been developed. In general, conventional reading or speed-reading through text media is based on the fast movement of the eyes between lines in order for readers to quickly read books and comprehend their contents, and accordingly, it is used for ordinary readers who must read a lot within a relatively short period or for students to improve their study efficiency.

Conventional speed-reading training uses speed-reading training figures on printed books or papers, so the trainees, speed-reading capabilities are improved by quickly, repeatedly, and step by step moving of the eyes from the right to the left, from the left to the right, from top to bottom, and from bottom to top on the basis of the above-noted training figures.

With this speed-reading training technique, the reader's reading ability is improved only by continuous repetition of the training based on the reader's will, and hence, many trainees become lazy in training or give up the training course in the middle. Also, since identical patterns of speed-reading training figures are repeatedly arranged, the reader may be frequently lost in the lines because of optical illusions during the speed-reading training, and accordingly, the reader's curiosity may be reduced, or they may easily feel bored because of the routine of the speed-reading training figures.

### SUMMARY OF THE INVENTION

It is an object of the present invention to provide a reading device and method using a display for outputting text data to a communication terminal having a liquid crystal display (LCD) (e.g., an electronic book, a digital caption player, a personal digital assistant (PDA) and a web pad), a computer or a network system having a monitor in a constant reading speed and a display mode according to the reader's definition so as to obtain better reading performance, and to provide a computer-readable recording medium that records a program for implementing the above method.

It is another object of the present invention to provide a speed-reading training device using a display for outputting text data to a communication terminal having an LCD (e.g., an electronic book, a digital caption player, a PDA), a computer or a network system having a monitor at a constant speed-reading training speed according to the reader's definition so as to obtain better speed-reading training performance, and to provide a computer-readable recording medium that records a program for implementing the above method.

In one aspect of the present invention, a reading device comprises: a storage unit for storing text data to be displayed; a selector for selecting a display mode and unit data, that is, a unit for displaying the data by a user; a controller for reading the text data from the storage unit for each selected unit data in response to the selected display mode and the unit data, and providing the reading unit data according to the selected display mode; and a display for receiving the unit data and visually displaying them.

In another aspect of the present invention, a reading method using a reading device comprises: (a) selecting a speed-reading mode and unit data by a user; (b) reading text data from a storage unit for each selected unit data and providing the same in response to the selected speed-reading mode and the unit data; and (c) receiving the unit data and visually displaying the same.

In still another aspect of the present invention, a computer-readable recording medium for recording a program implements (a) selecting a speed-reading mode and unit data by a user; (b) reading text data from a storage unit for each selected unit data and providing the same in response to the selected speed-reading mode and the unit data; and (c) receiving the unit data and visually displaying the same.

In yet another aspect of the present invention, a reading system on a network, comprises at least one server and at least one client, wherein the server comprises a storage unit for storing text data to be displayed; and a reading control program for controlling displaying of the text data according to the client's request, and wherein the reading control program comprises a selector for selecting a speed-reading mode and unit data by a user; and a controller for reading the text data from the storage unit for each selected unit data, and providing the read unit data to the client according to the selected speed-reading mode, in response to the selected speed-reading mode and the unit data.

The display speed for displaying the unit data is variable.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a reading device according to a first preferred embodiment of the present invention;

FIG. 2 shows a flowchart of a reading process according to the first preferred embodiment of the present invention;

FIG. 3 shows a reading window according to the first preferred embodiment of the present invention; FIGS. 4(a) and 4(b) show a display unit and a mode of the reading window according to the first preferred embodiment of the present invention;

FIG. 5 shows an inversion display mode according to the first preferred embodiment of the present invention;

FIG. 6 shows a deletion display mode according to the first preferred embodiment of the present invention;

FIG. 7 shows a data processing step by a processor according to the first preferred embodiment of the present invention;

FIG. 8 shows a reading method according to the second preferred embodiment of the present invention;

FIG. 9 shows an Internet system using a reading method according to a second preferred embodiment of the present invention;

FIG. 10 shows a reading icon according to the second preferred embodiment of the present invention;

FIG. 11 shows a normal reading or speed-reading exclusive device according to the second preferred embodiment of the present invention; and

FIG. 12 shows a display and a keypad of an exclusive device according to the second preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

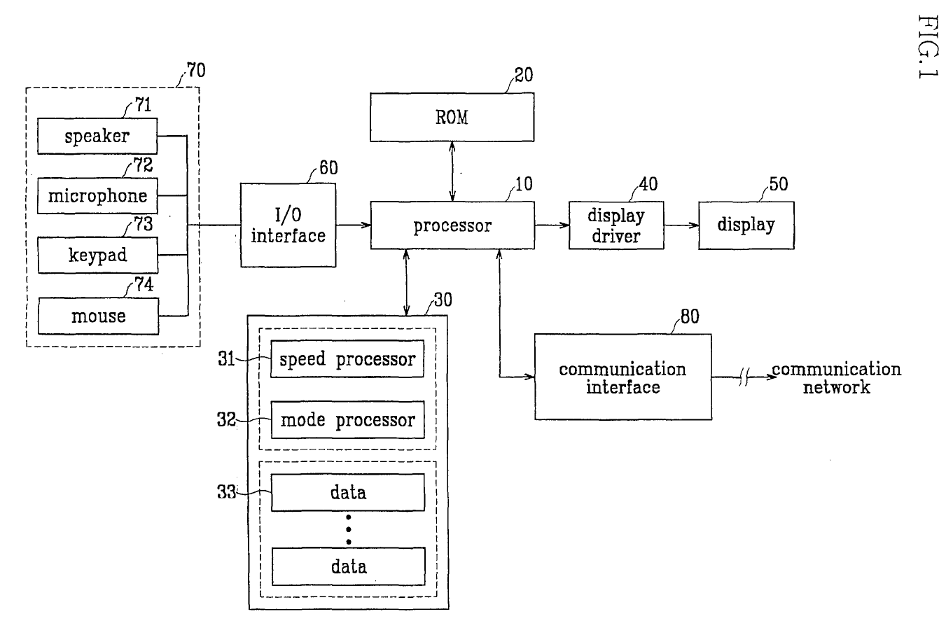

FIG. 1 shows a block diagram of a reading device having a display according to a first preferred embodiment of the present invention.

As shown, the reading device comprises a processor 10 for processing programs including a reading function according to the present invention; a memory 30 for storing a reading program according to the present invention and text data; a read only memory (ROM) 20 for storing general control programs of the reading device; a display driver 40 and a display 50 for displaying text; a communication interface 80 for downloading text data through communication; an input/output interface 60 for providing an interface function with a user; and a user interface 70.

The memory 30 includes at least two processors for implementing the reading function, that is, a display speed processor 31 and a display mode processor 32 as program formats. When the user selects an implementation function, the display speed processor 31 and the display mode processor 32 display stored text data to the display 50 on the basis of user selection data input through the user interface 70. Here, the text data include document data and voice data corresponding to the text data.

The user interface 70 comprises a speaker 71; a microphone 72; a keypad 73; and a mouse 74. The data input by the user are input to the processor 10 through the input/output interface 60 and are then processed. Also, the data processed by the processor 10 are provided to the user interface 70 through the input/output interface 60.

The display 50 comprises a cathode ray tube (CRT) or an LCD, and may further comprise another type of display for implementing the reading function of the present invention.

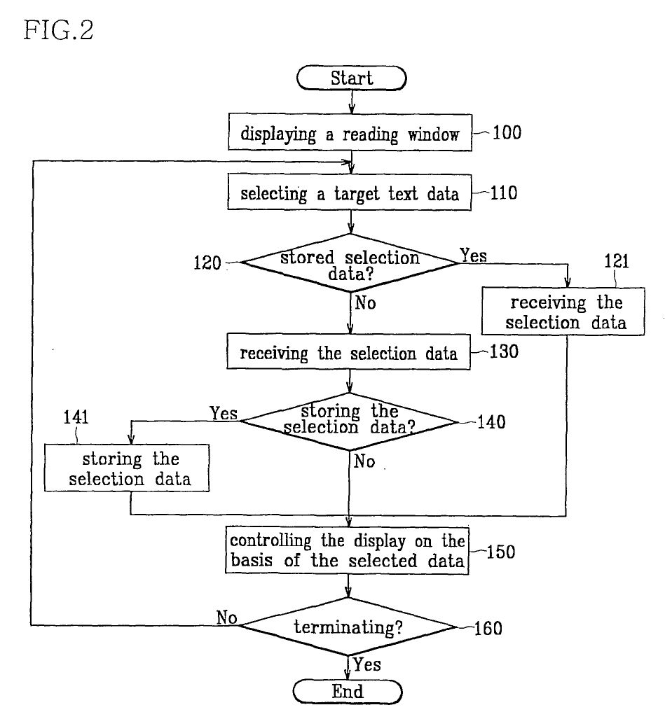

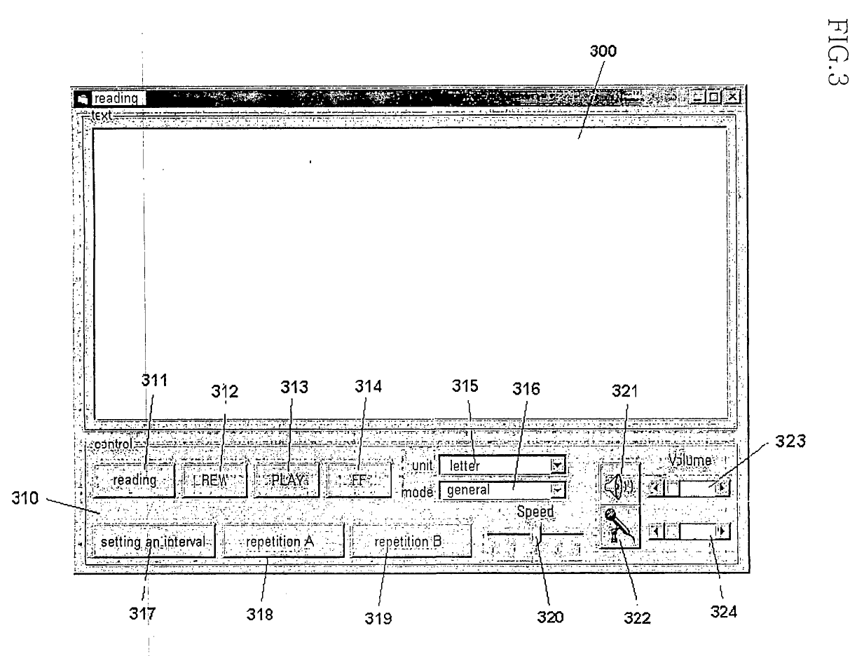

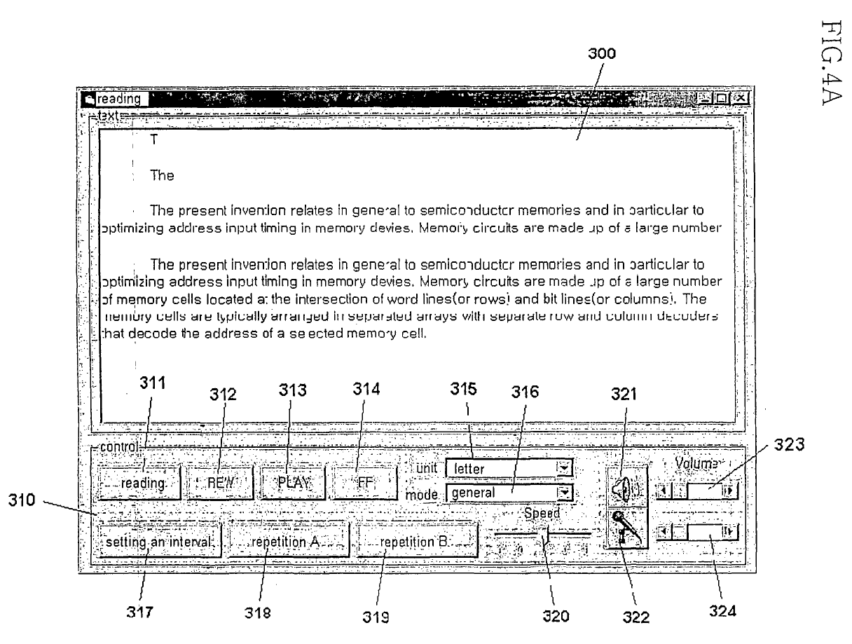

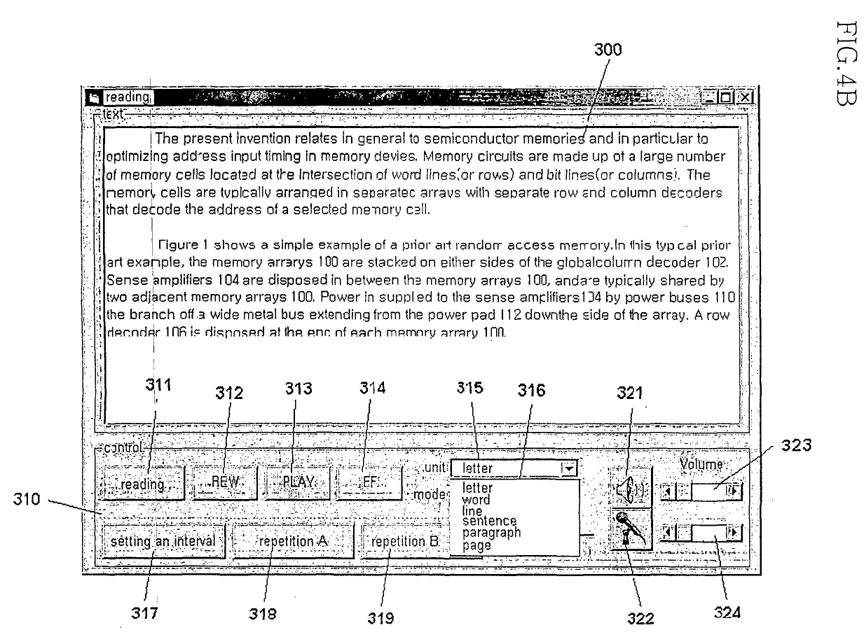

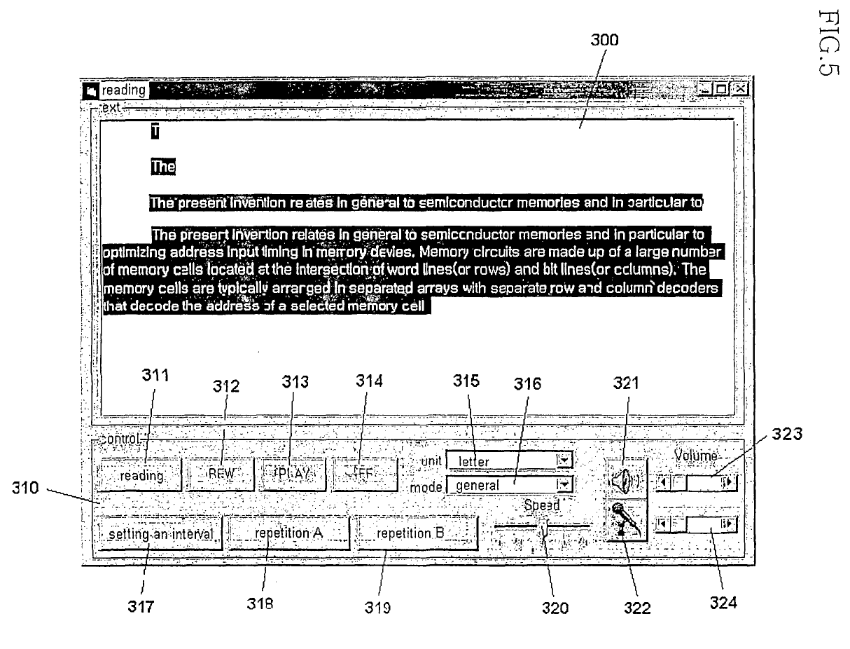

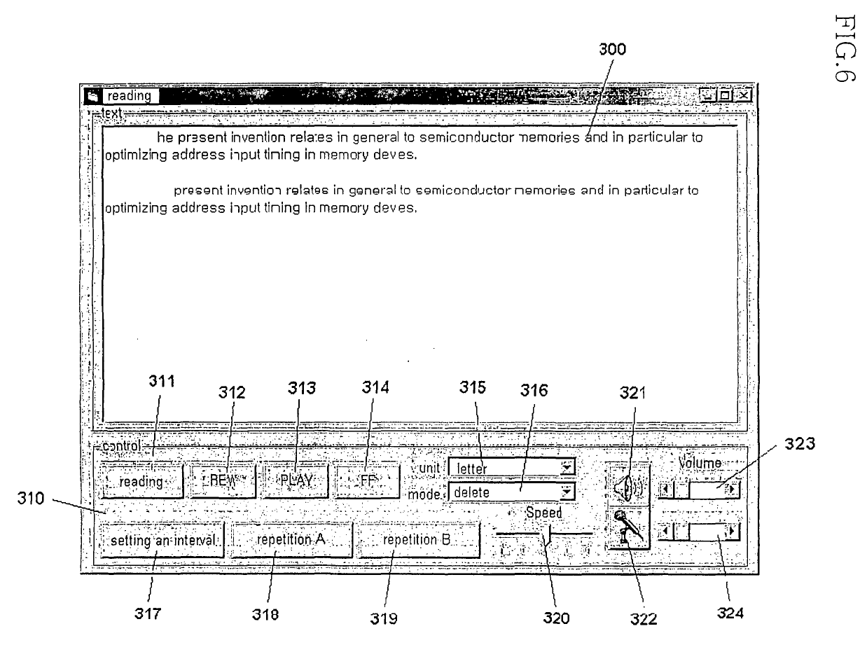

FIG. 2 shows a flowchart of a method for implementing the reading function according to the first preferred embodiment of the present invention. With reference to FIGS. 3 to 6, detailed descriptions on the reading function of FIG. 2 will be provided. FIG. 3 shows a reading window for implementing the reading function, FIGS. 4(a) and 4(b) show a display unit and a mode of the reading window, FIG. 5 shows an inversion display mode, and FIG. 6 shows a deletion display mode.

Initially, when an icon-type reading program provided on a window of a system is started, the processor 10 drives the display driver 40 so that the reading window as shown in FIG. 3 may be displayed on the display 50 in step S100.

As shown in FIG. 3, the reading window comprises a text display window 300 for displaying the text data, and a control panel 310. The control panel 310 comprises a plurality of switches including a file switch 311; a review switch 312; a play switch 313; a fast forward switch 314; a range setting switch 317; a repetition switch A 318; a repetition switch B 319; a speed adjust switch 320; a speaker switch 321; a microphone switch 322; and two volume adjustment switches 323 and 324. Also, the control panel 310 comprises a display unit selection window 315 and a display mode selection window 316.

When a signal caused by the user's manipulation of the file switch 311 is input through the user interface 70, the processor 10 selects a text desired by the user according to the file switch manipulation signal in step S110, and determines whether to use the data previously selected and stored by the user or to receive new data from the user in step S120. Here, the data corresponds to a condition for displaying the selected text.

In the case the user desires to use previously stored condition data as the condition data for representing how to display the selected text, the processor 10 reads the stored condition data from the memory S121, and in the case the user desires to select new condition data, the processor 10 receives signals input through the user interface 70 and sets new condition data in step S130.

In this case, as shown in FIG. 3, as to the condition data selected by the user, in connection with the switches provided to the control panel 310 of the reading window, the user selects one of the display options such as a letter, a word, a line, a sentence, a paragraph and a page as a display unit select data as shown in FIG. 4(a).

Also, the user may select a mode for displaying the text selected by the selected display unit to the display 50. The display mode according to the preferred embodiment of the present invention includes a general mode, an inversion mode, a delete mode, an emphasis mode, and an inversion/delete mode.

The general mode, as shown in FIGS. 4(a) and 4(b), represents a method for sequentially displaying the text data for each selected display unit, and the inversion mode as shown in FIG. 5 indicates a method for displaying text data for each page and sequentially inverting the displayed text data for each display unit. Here, the inversion represents inverting the colors of the text data and the background screen displayed on the screen.

The delete mode, as shown in FIG. 6, represents a display method for deleting display unit text data that precede the display unit text data that will be displayed. The emphasis mode similar to the inversion mode displays the text data that will be displayed for each page, and displays the display unit data using a well-known emphasis method. The inversion/delete mode concurrently uses the inversion mode and the delete mode to display the display unit data.

The user can also set the speed for displaying the text data for each selected display unit by using the speed adjust switch 320, and set or modify the display speed by using the review switch 312, the play switch 313 and the fast forward switch 314 provided on the control panel 310.

Also, the user can individually select the display unit using the range setting switch 317, and perform a repeated display operation using the repetition switch A 318 and the repetition switch B 319. Further, the user can set the speaker switch 321 as another function setting so as to provide audible data using the voice data included in the text data, and in particular, the user can perform foreign language speaking training using the microphone switch 322.

Two volume adjustment switches 323 and 324 are provided to the reading window so as to easily adjust the volume of the speaker and the microphone. By repeatedly providing the audible data or repeatedly checking the user's own voice, a language learning tool function can also be performed.

As described, when the user selects display condition data including, for example, by what unit the desired text will be displayed, how to display the text data according to the selected unit, and in what speed the text data will be displayed, that is, when the user sets a display unit, a display mode and a display speed, the user determines whether to store the selected condition data in step S140.

In the case of storing the selected data according to the user's selection, the processor 10 stored the selected condition data in the memory in step S141, and displays the text selected by the user to the display 50 on the basis of the selected condition data as shown in FIGS. 4 to 6 in step S150.

When the user desires to read the selected text on the basis of the previously stored condition data and not the new condition data, the processor 10 displays the text to the display 50 on the basis of the previously stored condition data provided by the memory 30 as shown in FIGS. 4 to 6.

As described, the text data that are displayed on the display 50 to be read by the user have various formats for displaying the documents such as html, xml, word and hwp as well as text.

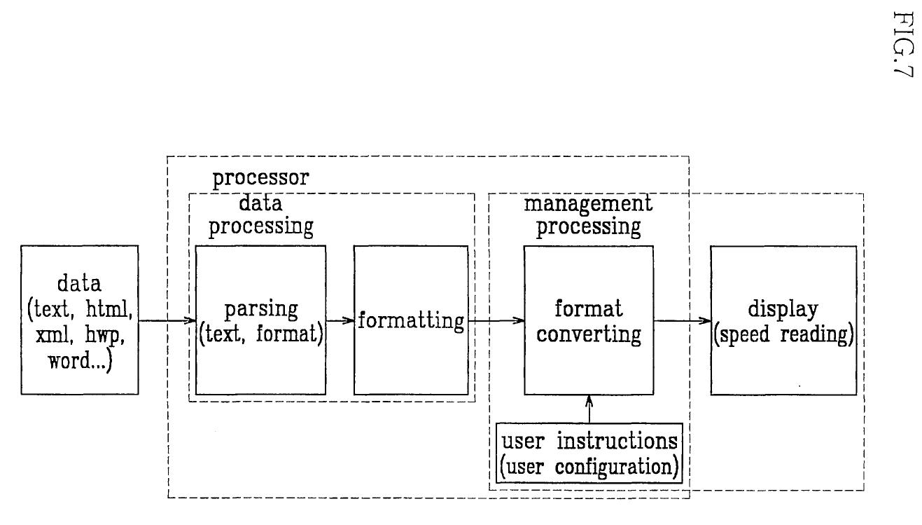

FIG. 7 shows a data processing step by the processor.

As shown, the processor 10 for processing various formats of text data uses a parser corresponding to each document format to analyze the corresponding document's format, and detects information that configures the documents such as the document's structure, text and the text's format. Here, the parser analyzes a predetermined document's format.

After the parsing process, the processor 10 reconfigures the input document into a reading data format that comprises reading data components that include types, fonts and context formats, and these reading data components are connected to each other.

The speed-reading data components can be extracted from the documents of all formats except for the text document format according to the parsing results, but since the text document does not have its own format, its speed-reading data components are extracted by applying a predetermined rule.

In the preferred embodiment of the present invention, a “word” is defined to be letters between the blanks, a “sentence” is defined to be a sequence of words from a start of a word to a period, and a “paragraph” is defined to be a sequence of sentences when a blank line is provided between two groups of sentences or when an indentation is provided at the start of a sentence, and the speed-reading data components are extracted on the basis of the above-defined rules.

Next, the processor 10 converts the format of the text data according to the condition data, that is, the display mode, the display speed and the display unit, and displays converted data.

The processor 10 determines whether the displaying of the selected text data is completed, and when it is found to be completed, the processor 110 determines whether to terminate the reading window. When a termination request is provided by the user, the reading window is terminated, and when the termination request is provided by the user, it goes to the previous step S110.

Accordingly, the user can read electronic documents or electronic books using a conventional mouse or a scroll key more effectively and more adaptively to the users, and an effective control method can be provided under a specific reading situation such as speed-reading. The speed-reading will be subsequently described in detail.

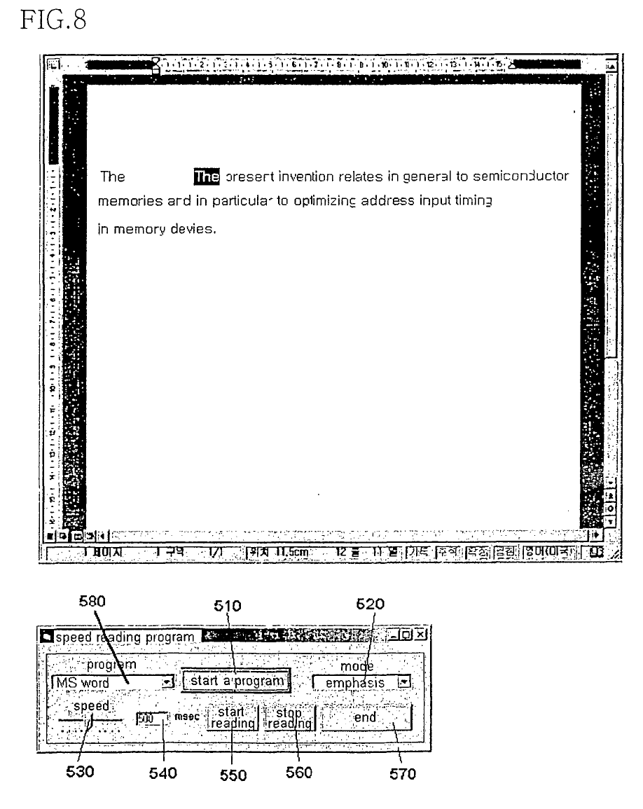

As shown in FIG. 8, the reading window according to the preferred embodiment of the present invention provides a control panel having the above-described functions so as to perform identical functions in the case the reading window has a text display window. That is, the above-noted reading method can be applied to word processors. In this case, the control panel comprises a switch for selecting a display unit; a switch 520 for setting a display mode; a speed selection unit 530 for conveniently controlling the speed; a display window 540 for visually informing the user of the user's own reading speed; and two switches 550 and 560 for selecting a start and a termination of the reading process. The control panel further comprises a program selection window 580 for selecting a desired word processor or another program including text data, and the selected program can be started by a program start switch 510.

When the display unit, the display mode and the speed are determined, the text is displayed according to the method as shown in FIGS. 4 to 6.

Therefore, the present invention can be easily applied to the case of reading the text data on the general Windows programs. In this case, the display mode is set to ‘line’, and the speed is set to control scrolling speed. The ease of this control method is an asset of the present invention.

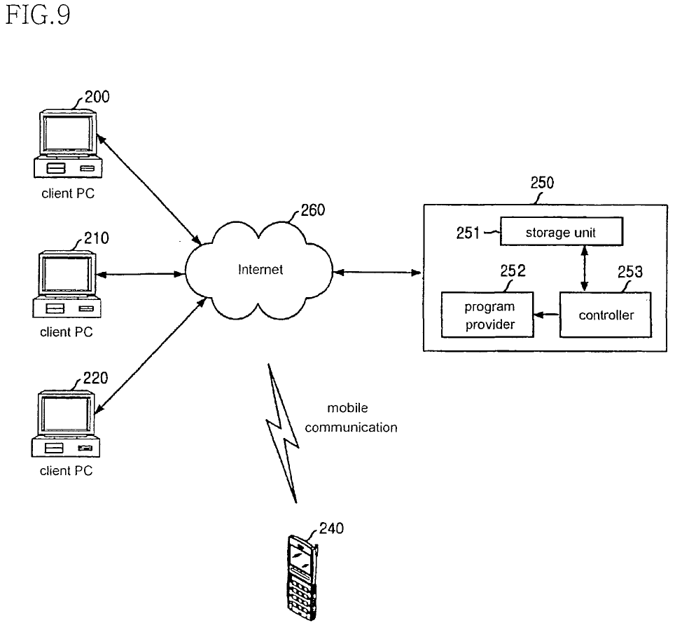

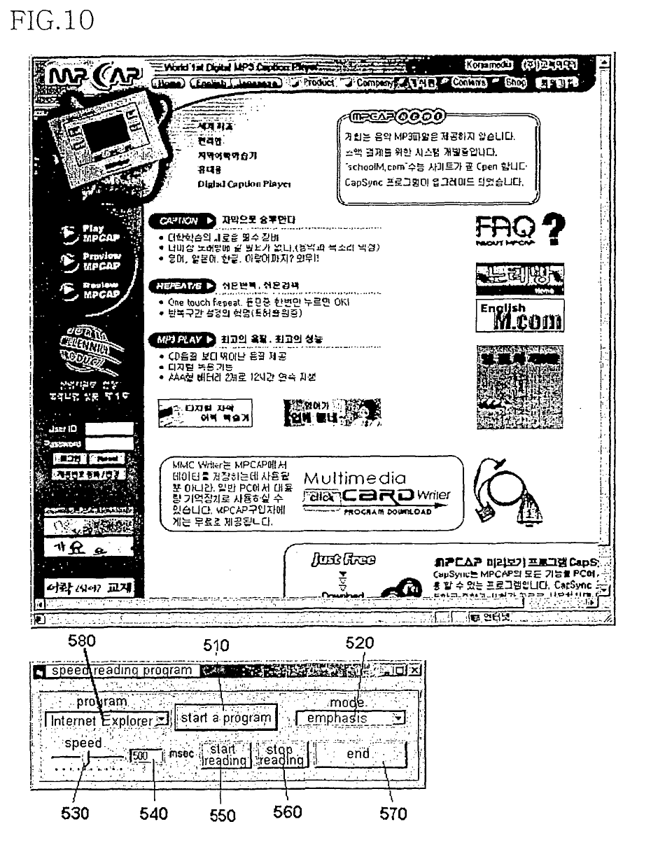

FIGS. 9 and 10 show an Internet-based reading system providing various display functions for reading or reading training according to a second preferred embodiment of the present invention.

As shown in FIG. 9, the reading system comprises at least one server system 250, and at least one client system 200, 210, or 220, and they are combined via the Internet 260 or wireless Internet. The server system 250 comprises a storage unit 251 for storing text data to be displayed through the client system; a selection program provider 252 for selecting a reading mode and unit data by the client system's user; and a controller 253 for reading the text data from the storage unit 251 for each selected unit data and outputting the same in response to the speed-reading mode and the unit data selected through the selection program.

The server system 250 transmits the user selection program as shown in FIG. 10 to a client system having a display. The selection program has a start program of an icon form provided on the default web page provided by the server system 250, and when a user who accesses the server system 250 via the Internet 26 selects the start program, the selection program for selecting a display mode for reading is started.

FIG. 10 shows an exemplified web page and a selection program window provided to the client system when a user accesses the server system through the Internet using the client system.

The selection program provides a display mode selection unit 520, a unit data selection unit 580 and a speed selection unit 530.

The display modes selectable by the display mode selection unit 520 represent the methods for displaying the selected unit data, and comprise first to fourth display modes in a like manner of the first preferred embodiment of the present invention.

The first display mode sequentially displays the selected data mode, the second display mode sequentially displays the unit data and deletes the preceding unit data, the third display mode displays the document selected for reading per page and inverts the unit data that will be displayed, and the fourth display mode deletes the preceding unit data in the third display mode.

The unit data selection unit 580 selects unit data displayable by the user, and the unit data include letters, words, lines, sentences, paragraphs and pages.

The speed selection unit 530 can be provided as a graph display window, a slide selection icon, or in other forms. The user can select a desired data speed for each display unit through the speed selection unit 530.

These selection units can be configured as icons or display windows on Internet web pages according to conventional methods, and can be optionally provided by the server system, or they can be optionally provided when the server system provides the text.

Also, the selection units can be optionally added to the web browser screens so that they may be easily reproduced when the user desires.

When the user of a client system sets a condition, that is, a speed-reading mode and unit data using the selection program, the server system 250 provides speed-reading training data to the client system according to the selected speed-reading mode and the unit data as described above.

Therefore, the present invention can be easily implemented in the above-described Internet-based system, and the web documents can be adapted to the user's reading speed and reading pattern without additional manipulation such as continual use of a mouse so as to read current documents, and further, it can execute effective speed-reading training using web documents and display information that fit the user's reading method so that the user can conveniently read the information.

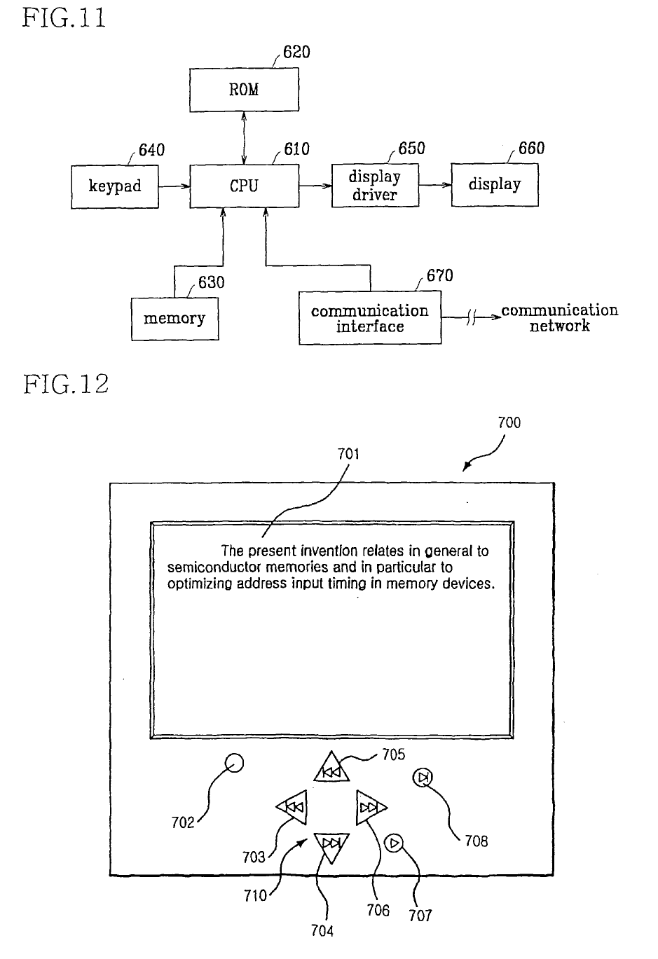

FIGS. 11 and 12 show a speed-reading training device that can be installed in a communication device having an audio player or an LCD to which an electronic book or a caption learning display is provided using a reading method according to a second preferred embodiment of the present invention.

FIG. 12 shows a display 701 for displaying text in various ways according to a selection of speed-reading training functions, and a function key input device 710 in the case of speed-reading training using the electronic book 700 having an LCD screen.

The function key input device 710 comprises a plurality of function keys including: up/down speed adjust keys 703 and 706 for increasing or decreasing the speed of the speed-reading training; a speed-reading training start/stop key 707; a temporary pause key 708 for temporarily pausing speed-reading training screens; a speed-reading mode select key 702; and up/down page shift keys 705 and 704.

A process for executing the speed-reading training using the speed-reading training device will now be described in detail.

First, text data for screen outputs needed for the speed-reading training are stored in a flash memory 630 for storing the text data of a device having an LCD such as an electronic book having speed-reading training functions keys and a display or an audio player having caption output functions.

This text data storing process is executed by downloading the electronic book data provided on line through a communication interface device 670 or by inserting an extendible memory card.

Under the state that the text data are stored in the flash memory 630, when an electronic book, an audio player or a computer having a display 660 is initialized and a speed-reading training mode is selected using a function key input device 640 so as to perform speed-reading training, a central processing unit (CPU) 610 adjusts the output speed of the text output to the display 660 into an appropriate value for the speed-reading training on the basis of the selected speed-reading training mode. A delayed output speed of the text for the speed-reading training is given as a default in the case of selecting a speed-reading training mode.

Next, the CPU 610 monitors the input states of the start/stop key 707 of the function key input device 640. Here, when the start/stop key 707 is input, a speed-reading training screen is output according to a key input sequence of the speed-reading mode select key 702.

On the speed-reading training screen, the first speed-reading mode displays each letter from left to right in the case of horizontal writing, and from top to bottom in the case of vertical writing.

The second speed-reading mode displays each line from top to bottom in the case of horizontal writing, and from right to left in the case of vertical writing.

The third speed-reading mode displays each line and deletes the preceding line in the case of horizontal writing, and from right to left in the case of vertical writing.

The fourth speed-reading mode displays one-page full contents and inverts them letter by letter from left to right in the case of horizontal writing, and from top to bottom in the case of vertical writing.

The fifth speed-reading mode displays one full page of content and inverts them line by line from left to right in the case of horizontal writing, and from top to bottom in the case of vertical writing.

The sixth speed-reading mode displays one full page of content and deletes each letter from left to right in the case of horizontal writing, and displays one full page of content and deletes each letter from top to bottom in the case of vertical writing.

The seventh speed-reading mode displays one full page of content, deletes each letter from left to right, and inverts a subsequent line in the case of horizontal writing, and displays one full page of content, deletes each letter from top to bottom, and inverts a subsequent line in the case of vertical writing.

The eighth speed-reading mode displays one full page of content at one time, and deletes them after a predetermined time.

The ninth speed-reading mode display selectively executes the first to seventh speed-reading modes to perform the speed-reading training in case vertical writing progresses from top to bottom and from left to right.

The tenth speed-reading mode writes each letter from left to right to form a line in the case of horizontal writing, and selectively inverts or deletes each letter or line in the case of horizontal writing from bottom to top.

The efficiency of the speed-reading training can be improved by gradually increasing the speed displayed on the speed-reading screen as time goes by. The gradual increase of the display screen speed on the speed-reading screen can be implemented by an automatic increase through a preset value or by a manual increase through key manipulation.

When a function key such as speed adjustment during the speed-reading training through the display screen is input, the CPU 610 executes a predetermined speed-reading screen control function according to input conditions of the function keys of the function key input device 640.

When the temporary pause key 708 of the function key input device 640 is input, the CPU 610 maintains the pause state on the current display screen, and when the temporary pause key 708 is input again, it goes to the previously established speed-reading mode.

When a repetition key is input, the CPU 610 receives the initial key and assigns a start point of a repetition interval, and when a next key is input, the CPU 610 assigns an ending point of the repetition interval to set the repetition interval, and when a start key is input, the CPU 610 repeats the corresponding set interval to display the speed-reading training screen.

When the up/down speed adjust keys 703 and 706 are input, the speed of generation, deletion or inversion of the letters or the lines on the speed-reading training screen is increased quickly or reduced slowly. By using this function, the training speed can be optimized according to the speed-reading performance for each person.

The up/down page shift keys 705 and 704 are used when the speed-reading trainee quickly searches for the desired page from among a plurality of text screens stored in memory and uses it as a speed-reading training screen.

When the trainee inputs the start/stop key 707 again while the speed-reading training is executed through the selection of the speed-reading training conditions and speed-reading modes, the CPU 610 determines it as an end of the speed-reading training using a display according to the input value of the start/stop key, and terminates the speed-reading training.

In like manner, the speed-reading training function using a display can be terminated through the manipulation of the function selection key.

As described above, various text data reading methods can be provided using a communication terminal having a display such as a device that has a text display, a text information memory, and an output device (e.g., an electronic book, a digital caption player and a PDA having an LCD) as well as a general computer system and an Internet system.

Ultimately, since a speed-reading training program for improving reading ability can be implemented, a reading or speed-reading trainee can select an appropriate speed-reading training method and exercise it, and accordingly, the trainee's speed-reading ability is improved within a shorter time. Once the trainee's speed-reading ability reaches a predetermined level, the present invention displays various kinds of information provided through the Internet to the trainee according to the trainee's reading ability, and hence, the trainee can read more data without manipulating a scroll bar with a mouse so that the trainee can conveniently read information on the display.

Also, the present invention can add a speed-reading training function to a device that has a text display, a text information memory and an output unit such as an electronic book or an audio player having a language learning function using a caption output method, without additional cost.

Further, the speed-reading training method can be applied to a computer or a television so that a computer monitor or a television can output the speed-reading training screens.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A reading device comprising:
a storage unit for storing text data to be displayed;
a selector for selecting a display mode and unit data, that is, a unit for displaying the data by a user;
a controller for reading the text data from the storage unit for each selected unit data in response to the selected display mode and the unit data, and providing the read unit data according to the selected display mode; and
a display for receiving the unit data and visually displaying them.

2. The reading device of claim 1, wherein the selector further comprises a speed selector for setting display speed for displaying the unit data, and the display further comprises a part for reading the unit data and outputting them according to the selected display speed.

3. The reading device of claim 1, wherein the display further comprises a part for deleting unit data that precede the unit data currently being displayed.

4. The reading device of claim 1, wherein the display further comprises a part for inverting unit data that precede the unit data currently being displayed.

5. The reading device of claim 1, wherein the display further comprises a part for concurrently outputting a plurality of unit data and deleting unit data that precede the unit data currently to be displayed.

6. The reading device of claim 1, wherein the display further comprises a part for concurrently outputting a plurality of unit data and inverting unit data that precede the unit data currently to be displayed.

7. The reading device of claim 1, wherein the display further comprises a part for concurrently outputting a plurality of unit data, and when a previously set time is passed, concurrently outputting the displayed unit data.

8. The reading device of claim 1, wherein the unit data is one of a letter, a word, a line, a paragraph, and a page.

9. The reading device of claim 1, wherein the selector further comprises a display mode selector for selecting a plurality of display modes by the user

10. The reading device of claim 9, wherein the display modes include at least one of a delete display mode for deleting a portion or all of previous display data, and an inverse display mode for inverting the currently displayed data.

11. The reading device of claim 1, wherein the selector further comprises a speed-reading mode stop part for stopping a speed-reading mode according to the user's selection.

12. The reading device of claim 1, wherein the selector comprises a plurality of exclusive buttons for selecting a speed-reading mode, unit data and display speed.

13. The reading device of claim 1, further comprising a communication part for receiving the display data from the outside.

14. A reading method using a reading device comprising:
(a) selecting a speed-reading mode and unit data by a user;
(b) reading text data from a storage unit for each selected unit data and providing the same in response to the selected speed-reading mode and the unit data; and
(c) receiving the unit data and visually displaying the same.

15. The reading method of claim 14, wherein (a) further comprises setting a display speed for displaying the unit data, and (c) further comprises outputting the unit data according to the selected display speed.

16. The reading method of claim 14, wherein (c) further comprises at least one of:
deleting unit data that precede the unit data currently being displayed;
inverting the unit data that precede the unit data currently being displayed;
concurrently outputting a plurality of unit data and deleting the unit data that precede the unit data currently to be displayed;
concurrently outputting a plurality of unit data and inverting the unit data that precede the unit data currently to be displayed; and
concurrently outputting a plurality of unit data, and when a previously set time is passed, concurrently outputting the displayed unit data.

17. The reading method of claim 14, wherein (a) further comprises selecting a plurality of display modes by the user, and (c) comprises at least one of: deleting a portion or all of previous display data; and inverting the currently displayed data.

18. A computer-readable recording medium for recording a program for implementing:
(a) selecting a speed-reading mode and unit data by a user;
(b) reading text data from a storage unit for each selected unit data and providing the same in response to the selected speed-reading mode and the unit data; and
(c) receiving the unit data and visually displaying the same.

19. The recording medium of claim 18, wherein (a) further comprises setting a display speed for displaying the unit data, and (c) further comprises outputting the unit data according to the selected display speed.

20. The recording medium of claim 18, wherein (c) further comprises at least one of:
deleting unit data that precede the unit data currently being displayed;
inverting the unit data that precede the unit data currently displayed;
concurrently outputting a plurality of unit data and deleting the unit data that precede the unit data currently to be displayed;
concurrently outputting a plurality of unit data and inverting the unit data that precede the unit data currently to be displayed; and
concurrently outputting a plurality of unit data, and when a previously set time is passed, concurrently outputting the displayed unit data.

21. The recording medium of claim 18, wherein (a) further comprises selecting a plurality of display modes by the user.

22. A reading system on a network, comprising at least one server and at least one client, wherein the server comprises a storage unit for storing text data to be displayed; and a reading control program for controlling displaying of the text data according to the client's request, and wherein the reading control program comprises a selector for selecting a speed-reading mode and unit data by a user; and a controller for reading the text data from the storage unit for each selected unit data and providing the read unit data to the client according to the selected speed-reading mode, in response to the selected speed-reading mode and the unit data.

23. The reading system of claim 22, wherein the client comprises a display for receiving the unit data and visually displaying them.

24. The reading system of claim 23, wherein the selector further comprises a speed selector for setting a display speed for displaying the unit data, and the display further comprises a part for reading and outputting the unit data according to the selected display speed.

25. The reading system of claim 24, wherein the display further comprises at least one of:
a part for deleting unit data that precede the unit data currently being displayed;
a part for inverting the unit data that precede the unit data currently displayed;
a part for concurrently outputting a plurality of unit data and deleting the unit data that precede the unit data currently to be displayed;
a part for concurrently outputting a plurality of unit data and inverting the unit data currently to be displayed; and
a part for concurrently outputting a plurality of unit data and when a previously set time is passed, concurrently outputting the displayed unit data.

26. The reading system of claim 22, wherein the display data comprise audio data for audibly displaying the display data, and the reading system further comprises an audio output part for audibly outputting the audio data.

27. The reading system of claim 22, wherein the server further comprises a microphone for receiving the user's voice in connection with the display data.

28. The reading system of claim 22, wherein the selector further comprises a display mode selector for selecting a plurality of display modes by the user, and the display mode is at least one of a delete display mode for deleting a portion or all of the previous display data and an inverse display mode for inverting the current display data.
